(19) United States
(12) Patent Application Publication
(10) Pub. No.: US 2005/0091060 A1
(43) Pub. Date: Apr. 28, 2005

(54) Hearing aid for increasing voice recognition through voice frequency downshift and/or voice substitution

(76) Inventor: Thomas W. Wing, Claremont, CA (US)

Correspondence Address: Kit M. Stetina, Esq.;STETINA BRUNDA GARRED & BRUCKER, Suite 250, 75 Enterprise, Aliso Viejo, CA, 92656, US

(21) Appl. No.: 10/691,689

(22) Filed: Oct. 23, 2003

(51) Int. Cl. G10L 11/00

(52) U.S. Cl. 704/271

(57) ABSTRACT

There is provided a digital hearing aid for increasing recognition of a voice in an ear. The hearing aid features a body member which is sized and configured to be engaged to the ear. A microphone is engaged to the body member for receiving an analog signal that defines the voice. Furthermore, a microchip is implanted within the body member for converting the analog signal from the microphone into a digital signal. This microchip is operative to modulate the digital signal by reducing a frequency thereof below a prescribed frequency level. The microchip is additionally operative to reconvert the digital signal back into the analog signal for delivery into the ear below the prescribed frequency level, hence increasing the recognition of the voice in the ear.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to hearing aids, and more particularly to a hearing aid which is adapted to increase voice recognition and intelligibility through frequency reduction of a voice below a prescribed frequency level (i.e., approximately 1200 hertz) and/or modification of the same to a substituted voice that is more readily recognizable and intelligible to its user.

The two types of hearing loss are conductive and sensorineural. Conductive hearing loss results from damage to the outer and middle ear while the sensorineural hearing loss (a.k.a. nerve hearing loss) involves damage to the inner ear. Although conductive hearing loss may typically be treated medically or surgically, sensorineural hearing loss, however, cannot usually be corrected via the same. Sensorineural hearing loss is the type of hearing loss which is most regularly managed with a hearing aid.

Unfortunately, sensorineural hearing loss is common in today's society as it can have many bodily and environmental causes. Some of its known causes are loud noises, head traumas, ear infections, aging, heredity and fluid buildups. However, sensorineural hearing loss does not affect all ranges of a person's hearing but rather only selective ranges thereof. Hence, the degree of hearing loss and the particular levels of sound frequencies affected typically vary from person to person.

In this respect, a person suffering from sensorineural hearing loss requires a hearing aid that is suited and tailored to his or her own unique sensitivity and the pattern of hearing loss. Although variously sized, styled, and shaped hearing aids are currently available for use to fit different hearing losses and different ear shapes, they nonetheless fail to account for acoustic needs of certain individuals.

For instance, senior citizens in society have a very difficult time understanding clearly and intelligibly voices of medium and high frequencies, that is, voices above 1200 hertz. This is because senior citizens, especially the males in that demographic, tend to have desensitized or destroyed higher frequency hair cells in their cochlea. Though they may be able to hear the general sounds in those specified frequency ranges, senior citizens, however, often cannot clarify each and every word spoken to them. Thus, senior citizens frequently may guess or estimate the words they hear or are spoken to them, and many times are incorrect in their interpretation.

In order to resolve this problem, senior citizens with such hearing loss resort to the use of hearing aids which are acoustically customized. More specifically, these hearing aids are modified to respond to the medium and high frequencies by amplifying the sounds above 1200 hertz. Although such sounds are better amplified and improvingly clarified, they, however, fail to clearly distinguish and differentiate each word of the voice.

Consequently, even though to the less extent, many senior citizens still find it troubling to hear voices in the medium to high frequency range. Those specifically pitched sounds remain to be somewhat unclear despite the use of the hearing aids. As such, the lack of clear voice recognition, enunciation and intelligibility of voices above 1200 hertz poses to be problematic and challenging in spite of the applications of the hearing aids.

In view of the above-described shortcomings of conventional hearing aids, there exists a need in the art for a hearing aid that can increase recognition and intelligibility of medium and high pitched voices above 1200 hertz. More specifically, there exists a need for a hearing aid which can clearly articulate and enunciate every word in voices of such frequency so as to effectively provide an optimal hearing in all spectrums of sound frequency.

### BRIEF SUMMARY OF THE INVENTION

The present invention specifically addresses and alleviates the above-referenced deficiencies associated with the use of the hearing aids of the prior art. More particularly, the present invention is an improved hearing aid which may increase voice recognition and intelligibility through frequency reduction of a voice below about 1200 hertz and/or modification of the same to a substituted voice that is more readily recognizable and intelligible to its user. As will be demonstrated below, the present hearing aid's adaptability to cover the frequency range above 1200 hertz effectively provides an optimal hearing in all ranges of sound frequency for individuals who are hard of hearing in that specified range.

In accordance with a first preferred embodiment of the present invention, there is provided a digital hearing aid which may increase voice recognition and intelligibility by reducing a high and medium frequency of a voice below about 1200 hertz. The hearing aid of the first preferred embodiment first features a body member which is designed to engage a damaged ear of its user. More specifically, the body member forming the present hearing aid may be fitted within or around the user's ear.

The body member includes a microphone which is placed outside the ear of the user or which is at least exposed to the surrounding environment. The placement of the microphone allows the sound waves to be received thereby. The microphone then converts the sound waves into analog signals. Although a single microphone may be used, it is contemplated herein that multiple microphones may be employed to improve voice reception.

A small computer microchip is implanted within the body member of the hearing aid and is operative to receive the analog signals which are transmitted from the microphone. This microchip is programmable using a specialized software from a computer (e.g., personal computer). However, the computer microchip of the present invention should be specifically programmed to modulate the voices in a manner as to lower the frequencies of voices down to about or below a prescribed frequency level (i.e., 1200 hertz).

By programming the computer microchip in such a manner, the hearing aid of the present invention provides an increased recognition and intelligibility of medium and high pitched voices above 1200 hertz. This allows individuals who are hard of hearing above that frequency range to effectively hear every word in the voice through reducing the frequency of the voice down to the level they feel most comfortable with.

The microchip further operates to convert the analog signals from the microphone into digital signals. In the first preferred embodiment of the present invention, the process of digitized sound processing is implemented for converting the analog signals into digital signals. As described above, the digital signals are subjected to frequency reduction or downshift via the application of the specific program embedded in the computer microchip. The digital signals are then reconverted to sound waves in an analog form so as to ultimately be delivered into the ear of the user about or below the prescribed frequency level (i.e., 1200 hertz).

More specifically, the reconverted electrical signal is transmitted to an amplifier that is located on the body member of the hearing aid. This is to allow the amplifier to produce amplification of the analog signals so as to make the sound louder in the user's ear. The amplified signals are then transmitted to a receiver for delivery of the same into the ear of the user. Furthermore, the present hearing aid employs the use of a conventional battery for operational power which is preferably engaged directly to the body member of the hearing aid.

In accordance with a second preferred embodiment of the present invention, there is provided a hearing aid of different design which may also increase the voice recognition and intelligibility in the ear of its user. However, instead of resorting to frequency reduction or downshift, the hearing aid of the second preferred embodiment achieves its objective through the use of a substituted voice that is more readily recognizable and intelligible to its user.

The hearing aid of the second preferred embodiment utilizes a speech processor which is located externally and apart from the general electrical components of the hearing aid. Such hearing aid possesses the similar general characteristics of its first version without the use of the microchip. Rather, it resorts to the use of an external control unit for processing the voice into the substituted voice in order to increase the recognition and intelligibility of the sounds in the user's ear.

The hearing aid of the second preferred embodiment is unlike the traditional hearing aids in the sense that it can actively interact with conventional hand-held electronic devices such as personal digital assistants (PDA), telephones or cellular phones. Simply put, the hearing aid of the second embodiment utilizes the current PDA and phone technology for the purpose of better understanding the words in the voice.

The hearing aid of the second preferred embodiment also features a microphone for picking up voices and a receiver for delivering the substituted voices into the user's ear. However, wirelessly disposed between those two electrical components is an externally located control unit. The control unit is placed physically apart from the microphone and receiver of the second embodied hearing aid but is connected therewith via a wireless communication.

Specifically, the control unit receives the voice wirelessly from the microphone which then processes the same into the substituted voice. Eventually, the external control unit transmits the substituted voice wirelessly to the receiver for delivery into the user's ear. In order to accomplish this objective, the control unit utilized in the second preferred embodiment includes a speech processor therewithin for processing the voice. More specifically, the speech processor converts and modifies the input signals from the microphone into patterns of electrical impulses. These signals are then transmitted wirelessly to the receiver which ultimately delivers the clarified and fine-tuned substituted voice into the user's ear for better hearing.

The external control unit may be placed in communication, preferably wirelessly, with the PDA or cellular phone so as to visually display the phrases of the voices in typed words through its visual display. In this respect, certain words which fail to be heard can be spelled out on the visual display. It should be recognized herein that LCD glasses may be utilized for this purpose as well.

The external control unit may also be configured to repeat each phrase heard immediately after it is pronounced. Furthermore, the external control unit may also be set to record longer conversations (e.g., phone conversation with family and friends). Moreover, the externally located control unit may incorporate the use of a translation software to translate the voices speaking a foreign language into English or vice-versa.

In operation, the hearing aid of both embodiments is designed to increase voice recognition and intelligibility by clearly articulating and enunciating every word in the spoken voices so as to provide optimal hearing. More specifically, the body member of the hearing aid is first engaged within or around the ear of the user. This allows the microphone of the hearing aid to detect the sound waves defining and forming the voices from the surrounding environment.

In the case of the first preferred embodiment, the voices picked up by the microphone are transmitted to a computer microchip for frequency reduction or downshift to about or below 1200 hertz. In the case of the second preferred embodiment, those voices are transmitted wirelessly to a speech processor of the externally located control unit so as to be processed into substituted voices.

Thereafter, the modified voices are transmitted to the receiver of the hearing aid for delivery into the user's ear. Of course, the amplifier may be used with the hearing aid to increase the loudness of the voices in the user's ear.

### BRIEF DESCRIPTION OF THE DRAWINGS

These as well as other features of the present invention will become more apparent upon reference to the drawings wherein:

FIG. 1 is a block diagram of a hearing aid constructed in accordance with a first preferred embodiment of the present invention and illustrating its computer microchip which is programmed to lower a frequency of a voice to about or below 1200 hertz;

FIG. 2 is a flow diagram illustrating the manner in which the hearing aid of FIG. 1 operates to lower the frequency of the voice to about or below 1200 hertz;

FIG. 3 is a block diagram of a hearing aid constructed in accordance with a second preferred embodiment of the present invention and illustrating its externally located control unit which is designed to modify a voice into a substituted voice that is more readily recognizable and intelligible to its user; and

FIG. 4 is a flow diagram illustrating the manner in which the hearing aid of FIG. 3 operates to modify the voice into the better recognizable and intelligible substituted voice.

### DETAILED DESCRIPTION OF THE INVENTION

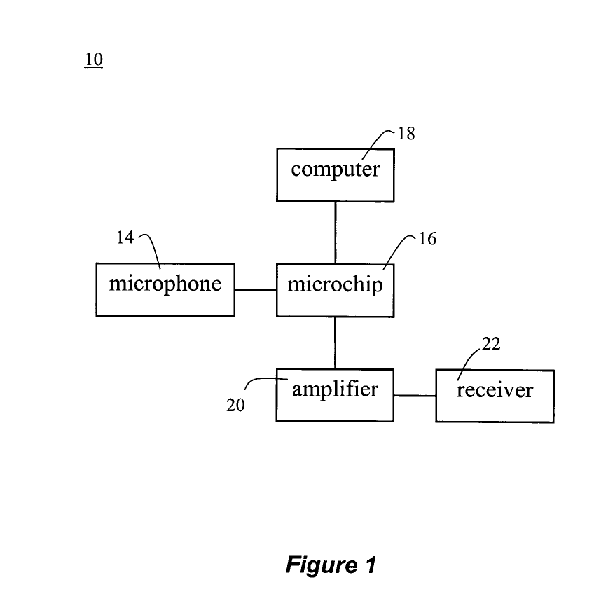

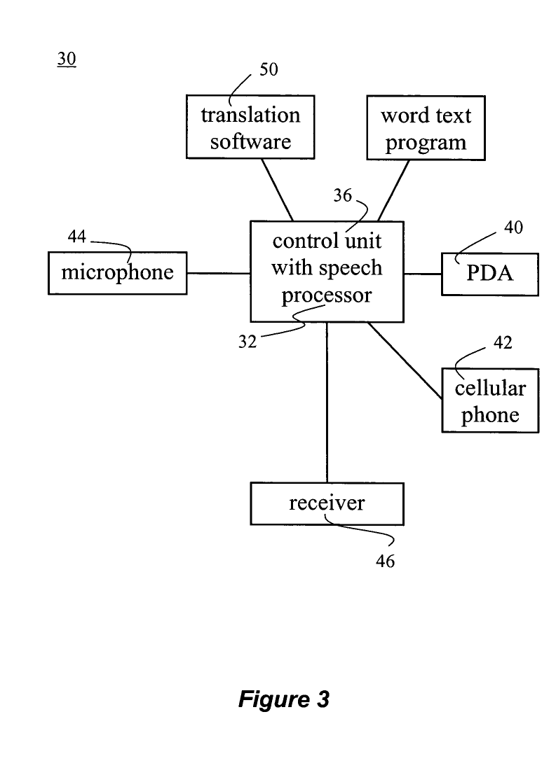

Referring now to the drawings wherein the showings are for purposes of illustrating preferred embodiments of the present invention only, and not for purposes of limiting the same, FIGS. 1 and 3 illustrate a hearing aid 10, 30 constructed in accordance with first and second preferred embodiments of the present invention. As indicated above, the present hearing aid 10, 30 is designed to increase voice recognition and intelligibility through frequency reduction of a voice below about 1200 hertz and/or modification of the same to a substituted voice that is more readily recognizable and intelligible to its user. Such adaptability to cover the frequency range above 1200 hertz effectively provides an optimal hearing in all ranges of sound frequency for individuals who are hard of hearing in that specified range.

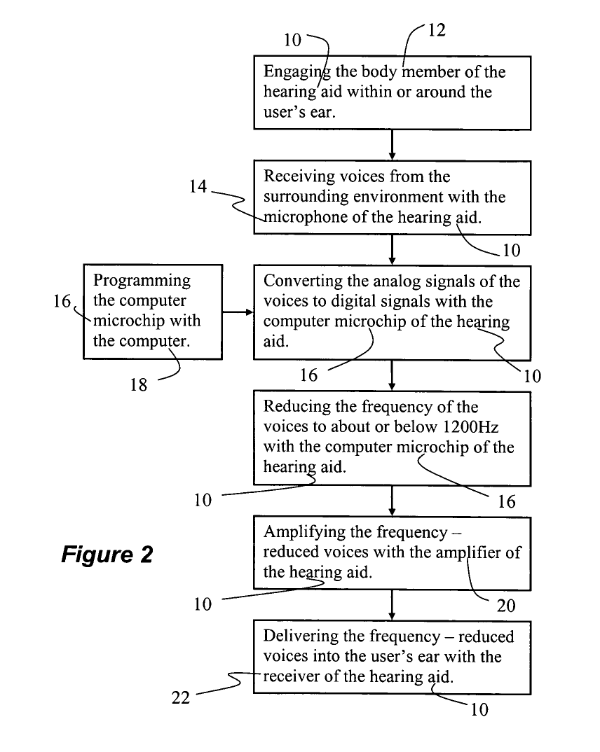

Referring more particularly to FIGS. 1 and 2, there is provided a hearing aid 10 of the first preferred embodiment which may increase voice recognition and intelligibility by reducing a high and medium frequency of a voice below about 1200 hertz. Although the concept of frequency reduction for the purpose of better hearing may be applied in all types of hearing aids, it should be noted herein that the hearing aid 10 of the first preferred embodiment is preferably a digital hearing aid. With that being clarified, the hearing aid 10 of the first preferred embodiment first features a body member 12 which is designed to engage a damaged ear of its user.

More specifically, the body member 12 forming the present hearing aid 10 may be fitted within the user's ear in accordance with conventional in-the-ear (ITE) or in-the-canal (ITC) types of hearing aid. In the alternative, such body member 12 may be worn around the ear of the user in accordance with conventional behind-the-ear (BTE) types of hearing aid. Regardless of which type of design the body member 12 follows, it is the concept of reducing the sound frequency for clarifying a voice that should be appreciated as it is one of the primary essence of the present invention.

The body member 12 includes a microphone 14 which is placed outside the ear of the user (if following BTE design) or which is at least exposed to the surrounding environment (if following the ITE or ITC design) . Either of the two positioning would allow the microphone 14 to pick up the sound waves from the surrounding environment. The microphone 14 then converts the sound waves into electrical signals in their analog form. Although the use of a single traditional microphone 14 is contemplated in the first preferred embodiment of the present invention, it should be recognized herein that a directional microphone or multiple microphones may be utilized instead to improve voice reception.

A small computer microchip 16 is implanted within the body member 12 of the hearing aid 10 and is operative to receive the analog signals which are transmitted from the microphone 14. As is done with many digitally-programmable hearing aids now available in the marketplace, this microchip 16 is computer programmable by an audiologist or the like. In particular, the microchip 16 is programmable using a specialized software from a computer 18 (e.g., personal computer).

However, the computer microchip 16 of the present invention should be specifically programmed to modulate the voices in a manner as to lower the frequencies of voices down to about or below a prescribed frequency level. The prescribed frequency level in the first preferred embodiment of the present invention is about 1200 hertz. By programming the computer microchip 16 in this specific manner, the hearing aid 10 of the present invention provides an increased recognition and intelligibility of medium and high pitched voices above 1200 hertz. This allows individuals who are hard of hearing above that frequency range to effectively hear every word in the voice through reducing the frequency of the voice down to the level they feel most comfortable with. Of course, if the hearing needs of the individuals change over time (e.g., hard to hear above 1000 hertz), the microchip 16 may always be reprogrammed to accommodate the specific hearing needs of each individual.

Prior to lowering the frequency of the voice down to about or below the prescribed frequency level (i.e., 1200 hertz), the microchip 16 operates to convert the analog signals from the microphone 14 into digital signals. In the first preferred embodiment of the present invention, the process of digitized sound processing is implemented for converting the analog signals into digital forms. The specific details of the digitized sound processing will not be duplicated herein as such process is a common knowledge in the field.

As one of ordinary skill in the art is fully aware, the digitized sound processing generally involves analyzing the signals to determine if the sound is a voice or a mere background noise. The process then generally involves filtering the voice signals apart from the background noise so as to make modifications which would provide clear and distortion-free digital signals. The signals can then be manipulated according to the individuals' hearing levels and listening needs.

As described above, the digital signals are subjected to frequency reduction or downshift via the application of the specific program programmed in the computer microchip 16. The digital signals are then reconverted to sound waves in an analog form so as to ultimately be delivered into the ear of the user about or below the prescribed frequency level (i.e., 1200 hertz). This increases the voice recognition and intelligibility to the user's ear.

More specifically, the reconverted electrical signal is transmitted to an amplifier 20 that is located on the body member 12 of the hearing aid 10. This is to allow the amplifier 20 to produce amplification of the analog signals so as to make the sound louder in the user's ear. It should be noted that the amplified signals are already reduced or downshifted to about or below the prescribed frequency level (i.e., 1200 hertz).

The amplified signals are then transmitted to a receiver 22 for delivery of the same into the ear of the user. As is commonly understood, a receiver 22 in a typical hearing aid is essentially a miniature loudspeaker which is utilized for ultimately delivering the amplified sound into the ear of the user. Optionally, an earmold or earpiece (not shown) may be additionally used to direct the flow of sound into the ear of the user and enhance sound quality.

Obviously, the hearing aid 10 of the present invention requires a power supply for obtaining operational power and powering various electronic parts thereof (e.g., microphone 14, amplifier 20, receiver 22, etc.) . For this purpose, the present hearing aid employs the use of a conventional battery 24 which is preferably engaged directly to the body member 12 of the hearing aid 10. However, alternative power supplies may be applied in lieu thereof such as a carry-on battery pack or a power cord leading to an electrical outlet (not shown).

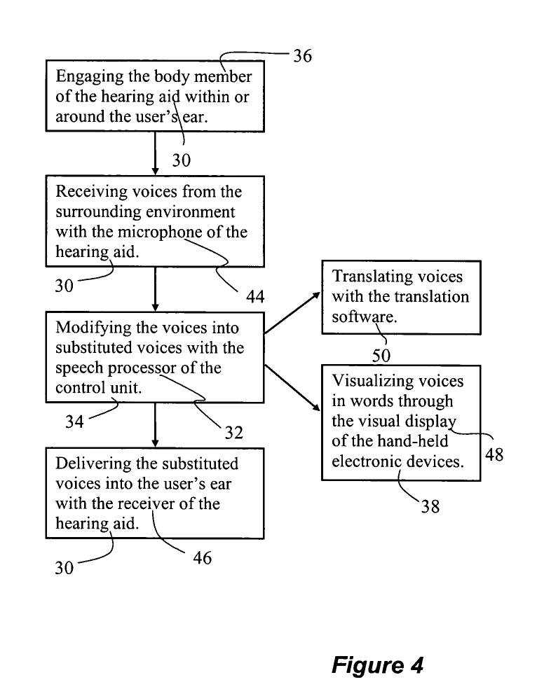

Referring now to FIGS. 3 and 4 which depict the second preferred embodiment of the present invention, there is provided a hearing aid 30 of different design which may also increase the voice recognition and intelligibility in the ear of its user. However, instead of resorting to frequency reduction or downshift, the hearing aid 30 of the second preferred embodiment achieves its objective through the use of a substituted voice that is more readily recognizable and intelligible to its user. Of course, such voice may be the one with a sound frequency at about or below 1200 hertz for people who are hard of hearing above that frequency level.

The main difference of the hearing aid 30 of the second preferred embodiment from the first preferred version is the use of a speech processor 32 for providing the recognizable substituted voice. In this regard, it is contemplated herein that the hearing aid 10 of the first preferred embodiment may be structurally modified to incorporate the use of the speech processor 32 or replace its computer microchip 16 therewith.

However, the hearing aid 30 of the second preferred embodiment utilizes a speech processor 32 which is located externally and apart from the general electrical components of the hearing aid 30. Such hearing aid 30 possesses the similar general characteristics of its first version. However, the use of the microchip 16 is not necessary. Rather, it resorts to the use of an external control unit 34 for processing the voice into the substituted voice in order to increase the recognition and intelligibility of the sounds in the user's ear.

Similar to the hearing aid 10 of the first preferred embodiment, the body member 36 of the second embodied hearing aid 30 is designed to be engaged to the ear of the user. As such, the body member 36 of the hearing aid 10 of the second preferred embodiment also follows the traditional body configurations of the ITE, ITC or BTE hearing aid types. However, the hearing aid 30 of the second preferred embodiment is unlike the traditional hearing aids in the sense that it can actively interact with conventional hand-held electronic devices 38 such as personal digital assistants (PDA) 40, telephones or cellular phones 42. Simply put, the hearing aid 30 of the second embodiment utilizes the current PDA and phone technology for the purpose of better understanding the words in the voice.

Further similar to the hearing aid 10 of the first preferred embodiment, the hearing aid 30 of the second preferred embodiment which interacts with a conventional PDA 40 or cellular phone 42 features a microphone 44 for picking up voices and a receiver 46 for delivering the substituted voices into the user's ear. However, wirelessly disposed between those two electrical components is an externally located control unit 34. The control unit 34 is placed physically apart from the microphone 44 and receiver 46 of the second embodied hearing aid 30 but is connected therewith via a wireless communication. However, wired communication is specifically contemplated herein. Moreover, the control unit 34 may be either located at a place proximate or distant from the hearing aid 30, or can be configured to be worn by the user's body.

Specifically, the control unit 34 receives the voice wirelessly from the microphone 44 which then processes the same into the substituted voice. Eventually, the external control unit 34 transmits the substituted voice wirelessly to the receiver 46 for delivery into the user's ear. In order to accomplish this objective, the control unit 34 utilized in the second preferred embodiment includes a speech processor 32 therewithin for processing the voice. It should be stated herein that additional batteries may be used in the PDA 40 or cellular phone 42 to carry out and maintain its increased operational use.

Speech processors and their use have been around for years. Hence, the specific details of the speech processors will not be duplicated herein as they are fairly common knowledge in the field. However, their interaction with the hearing aid 30 of the second preferred embodiment will be described since such use is believed to a novel concept unique to the present invention.

The voices which are picked up by the microphone 44 of the hearing aid 30 of the second preferred embodiment are transmitted wirelessly to the speech processor 32 of the external control unit 34. Through the use of a speech processing algorithm, the speech processor 32 extracts various parameters from the signals transmitted from the microphone 44 and determines the amplitude of the current pulses to be sent back to the hearing aid 30, namely, its receiver 46. More specifically, the speech processor 32 converts and modifies the input signals from the microphone 44 into patterns of electrical impulses. These signals are then transmitted wirelessly to the receiver 46 which ultimately delivers the clarified and fine-tuned substituted voice into the user's ear for better hearing.

The external control unit 34 may be placed in communication, preferably wirelessly, with the PDA 40 or cellular phone 42 so as to visually display the phrases of the voices in typed words through its visual display 48. Computer programs such as Naturally Speaking or IBM may be utilized for changing spoken voices into text. In this respect, certain words which fail to be heard can be spelled out on the visual display 48 of the PDA 40 or cellular phone 42. Inversely, the user of the hearing aid 30 can also type out the words in his or her PDA 40 or cellular phone 42 for transmission of the message to the other party. It should be recognized herein that LCD glasses (not shown) may be utilized for this purpose as well.

In addition to processing the voices into substituted voices, the external control unit 34 may be configured to repeat each phrase heard immediately after it is pronounced. This repetition allows the brain time to absorb what is said and thus may be beneficial since not all hearing problems are due to lack of hearing. Furthermore, the external control unit 34 may also be set to record longer conversations (e.g., phone conversation with family and friends). In this respect, the user of the hearing aid 30 of the second embodiment (e.g., senior citizens) may later process the conversation by playing back and trying different programs in order to make sense of the previous conversation. This would eliminate the embarrassment of asking the person to repeat himself or herself.

Moreover, the externally located control unit 34 may incorporate the use of a translation software 50 to translate the voices speaking a foreign language into English or vice-versa The translated voices may be delivered into the user's ear by the receiver or reproduced by the speaker of the PDA 40 or cellular phone 42.

The general operation of the hearing aid 10, 30 of the first and second preferred embodiments is described herein. The hearing aid 10, 30 of both embodiments is designed to increase voice recognition and intelligibility by clearly articulating and enunciating every word in the spoken voices so as to provide optimal hearing. More specifically, the body member 12, 36 of the hearing aid 10, 30 is first engaged within or around the ear of the user. This allows the microphone 14, 44 of the hearing aid 10, 30 to detect the sound waves defining and forming the voices from the surrounding environment.

In the case of the first preferred embodiment, the voices picked up by the microphone 14 are transmitted to a computer microchip 16 for frequency reduction or downshift to about or below 1200 hertz. In the case of the second preferred embodiment, those voices are transmitted wirelessly to a speech processor 32 of the externally located control unit 34 so as to be processed into substituted voices.

Thereafter, the modified voices are transmitted to the receiver 22, 46 of the hearing aid 10, 30 for delivery into the user's ear. Of course, the amplifier 20 may be used with the hearing aid 10, 30 to increase the loudness of the voices in the user's ear.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

1. A digital hearing aid for increasing recognition of a sound in an ear, the hearing aid comprising:
a body member sized and configured to be engaged to the ear;
a microphone engaged to the body member for receiving an analog signal defining the sound;
a microchip implanted within the body member for converting the analog signal from the microphone into a digital signal, the microchip being operative to reduce a frequency of the digital signal below a prescribed frequency level, the microchip further being operative to reconvert the digital signal back into the analog signal; and
a receiver engaged to the body member for delivering the analog signal below the prescribed frequency level into the ear so as to increase the recognition of the sound in the ear.

2. The hearing aid of claim 1 further comprising an amplifier engaged to the body member for amplifying the analog signal below the prescribed frequency level.

3. The hearing aid of claim 1 further comprising a battery engaged to the body member for providing power to the hearing aid.

4. The hearing aid of claim 1 wherein the body member is fitted within the ear.

5. The hearing aid of claim 1 wherein the body member is worn around the ear.

6. The hearing aid of claim 1 wherein the microphone is operative to convert the sound into the analog signal.

7. The hearing aid of claim 1 wherein the microchip is operative to convert the analog signal into the digital signal through digitized sound processing.

8. The hearing aid of claim 7 wherein the microchip analyzes and filters the digital signal of the voice apart from a background noise.

9. The hearing aid of claim 1 wherein the microchip is programmable via a software of a computer for reducing the frequency of the digital signal below the prescribed frequency level.

10. The hearing aid of claim 1 wherein the prescribed frequency level is about 1200 hertz.

11. A method of increasing recognition of a sound in an ear with a hearing aid, the hearing aid having a microphone, a microchip and a receiver, the method comprising the steps of:
a) engaging a body member of the hearing aid to the ear;
b) receiving an analog signal defining the sound with the microphone of the hearing aid;
c) converting the analog signal from the microphone into a digital signal with the microchip of the hearing aid;
d) reducing a frequency of the digital signal below a prescribed frequency level with the microchip;
e) reconverting the digital signal back into the analog signal with the microchip; and
f) delivering the analog signal below the prescribed frequency level into the ear with the receiver of the hearing aid so as to increase the recognition of the sound in the ear.

12. The method of claim 11 wherein the hearing aid further comprises an amplifier, and wherein prior to step f) the method comprises the step of amplifying the analog signal below the prescribed frequency level with the amplifier.

13. The method of claim 11 wherein the hearing aid further comprises a battery, and wherein prior to step a) the method comprises the step of providing power to the hearing aid with the battery.

14. The method of claim 11 wherein step a) comprises fitting the body member within the ear.

15. The method of claim 11 wherein step a) comprises wearing the body member around the ear.

16. The method of claim 11 wherein step b) comprises converting the sound into the analog signal with the microphone.

17. The method of claim 11 wherein step c) comprises converting the analog signal into the digital signal with the microchip through digitized sound processing.

18. The method of claim 11 wherein step d) comprises programming the microchip via a software of a computer for reducing the frequency of the digital signal below the prescribed frequency level.

19. The method of claim 11 wherein step d) comprises reducing the frequency of the digital signal below about 1200 hertz.

20. A hearing aid for increasing recognition of a sound in an ear, the hearing aid comprising:
a body member sized and configured to be engaged to the ear;
a microphone engaged to the body member for receiving the sound;
a receiver engaged to the body member for reproducing a substituted sound in the ear; and
a control unit located externally from the body member and being in wireless communication with the microphone and the receiver thereof, the control unit being operative to receive the sound wirelessly from the microphone to process the sound into the substituted sound, the control unit further being operative to transmit the substituted sound wirelessly to the receiver for reproducing the substituted sound in the ear and increase the recognition of the sound in the ear.

21. The hearing aid of claim 20 wherein the hearing aid is a digital hearing aid.

22. The hearing aid of claim 20 wherein the control unit is further in communication with a hand-held electronic device having a visual screen, the visual screen being sized and configured to visually display the sound received by the microphone as a word.

23. The hearing aid of claim 22 wherein the hand-held device is a personal digital assistant.

24. The hearing aid of claim 22 wherein the hand-held device is a cellular phone.

25. The hearing aid of claim 20 wherein the control unit is operative to record the sound received from the microphone.

26. The hearing aid of claim 20 wherein the control unit comprises a sound processor for processing the sound into the substituted sound.

27. The hearing aid of claim 20 wherein the control unit comprises a translation software for translating the sound into the substituted sound of a selected language.

28. The hearing aid of claim 12 wherein the substituted sound has a frequency below about 1200 hertz.

29. A method of increasing recognition of a sound in an ear with a hearing aid, the method comprising the steps of:
a) engaging a body member of the hearing aid to the ear;
b) receiving the sound with the microphone of the hearing aid;
c) transmitting the sound wirelessly from the microphone to the control unit of the hearing aid;
d) processing the sound into a substituted sound with the control unit;
e) transmitting the substituted sound wirelessly from the control unit to the receiver of the hearing aid; and
f) reproducing the substituted sound in the ear to increase the recognition of the sound in the ear.

30. The method of claim 29 wherein the hearing aid is a digital hearing aid.

31. The method of claim 29 further comprising a hand-held electronic device having a visual screen, and wherein step d) comprises:
1) transmitting the sound from the control unit to the hand-held electronic device; and
2) displaying the sound visually on the visual screen of the hand-held electronic device as a word.

32. The method of claim 31 wherein the hand-held device is a personal digital assistant.

33. The method of claim 31 wherein the hand-held device is a cellular phone.

34. The method of claim 29 wherein step d) comprises recording the sound received from the microphone with the control unit.

35. The method of claim 29 wherein the control unit has a sound processor, and wherein step d) comprises processing the sound into the substituted sound with sound processor.

36. The method of claim 29 wherein the control unit has a translation software, and wherein step d) comprises translating the sound into the substituted sound of a selected language with the translation software.

37. The method of claim 29 wherein the substituted sound has a frequency below about 1200 hertz.
